(19) United States
(12) Patent Application Publication
(10) Pub. No.: US 2015/0310574 A1
(43) Pub. Date: Oct. 29, 2015

(54) PROTOCOL BUILDER FOR MANAGING PATIENT CARE

(71) Applicants: Christopher A. Williams, Wallingford, PA (US); Charles Presby Giammattei, Swarthmore, PA (US)

(72) Inventors: Christopher A. Williams, Wallingford, PA (US); Charles Presby Giammattei, Swarthmore, PA (US)

(21) Appl. No.: 14/261,846

(22) Filed: Apr. 25, 2014

(51) Int. Cl. G06Q 50/22; G06F 19/00; G06Q 10/00

(52) U.S. Cl. CPC G06Q 50/22; G06Q 10/00; G06F 19/327

(57) ABSTRACT

A system and method are provided that enable doctors and nurses to easily establish patient protocols and to track and manage patient compliance with those protocols and to track medications with patient outcome to determine the best medications and treatments for various diseases. Protocol builder software permits the doctor or nurse to build a customized patient protocol on a timeline including one-time events (e.g., survey) tied to an anchor date (e.g., surgery) and periodic events (e.g., taking of medication). The patient is prompted to respond to the protocols using elected communications methods, and patient compliance with the protocol is stored in a database with the protocol. The physician may adjust the protocol to reflect the physician's preferences. The captured data is stored in a database and searched to enable the physician to compare how the proposed protocols have worked for other patients with similar conditions, to predict disease (symptoms, side effects) and to adjust the patient's protocol as appropriate.

### TECHNICAL FIELD

The present application relates to a system and method for managing patient care by building a protocol based on the patient's chronic illness, acute care needs, and/or surgery so that the patient's care may be optimally managed by the patient and the physician.

### BACKGROUND

Significant time and effort are being expended to automate aspects of the doctor-patient relationship to improve efficiencies. Also, many efforts are underway to improve the capture of a patient's electronic health records to facilitate search and diagnosis. However, the inventors are not aware of any systems that are designed to enhance the doctor-patient relationship by designing protocols that are unique to each patient and easily designed and maintained by the patient's doctor to enhance patient compliance and ongoing monitoring of the patient's condition. In addition, the inventors are not aware of protocol builders that provide for building patient protocols around particular events such as a surgery in order to enhance patient compliance with the pre- and post-surgical regimen. A patient protocol builder tool is desired that permits a doctor or nurse to easily create a customized patient protocol and to automate the compliance process for complying with the protocol. The invention addresses these significant needs in the art.

### SUMMARY

A system and method are provided that address the above-mentioned needs in the art by enabling doctors and nurses to easily establish patient protocols and to track and manage patient compliance with those protocols and to track medications with patient outcome to determine the best medications and treatments for various diseases. Protocol builder software is provided that permits the doctor or nurse to build a customized patient protocol on a timeline including one-time events (e.g. surgery) and periodic events (e.g., taking of medication). The patient is prompted to respond to the protocols using elected communications methods, and patient compliance with the protocol is stored in a database with the protocol. The physician may adjust the protocol to reflect the physician's preferences. The captured data is stored in a database and searched to enable the physician to compare how the proposed protocols have worked for other patients with similar conditions and to adjust the patient's protocol as appropriate. The results may also be used to predict the best treatment option for that patient.

In an exemplary embodiment, a method of managing patient care is provided that includes the steps of creating a treatment protocol customized for the patient, the patient protocol including one-time events and periodic events relating to patient care and tied to an anchor date; automatically contacting the patient in a customized manner to notify the patient of one-time and periodic events requiring patient action and accepting indications from the patient of compliance with the required patient action as well as patient symptom data; storing the customized treatment protocol, patient compliance information and patient symptom data in a database; and enabling a patient's caregiver to modify the customized patient protocol based on the patient's compliance with any required patient actions and feedback from the patient relating to patient symptoms. In exemplary embodiments, the anchor date is a proposed surgery date. Once the customized patient protocol has been established, the patient is automatically contacted in a customized manner including sending recorded messages to the patient in the patient's caregiver's voice informing the patient of the required patient action according to the patient's customized treatment protocol.

In exemplary embodiments, the customized treatment protocol, patient compliance information and patient symptom data are stored in the database for many patients and the database is searched to find patients with similar treatment conditions for use in predicting which treatment options will work best for the patient and predicting when disease symptoms, drugs side effect and disease itself will occur. The database is searched to find patients with similar treatment conditions by applying weightings to the conditions as specified by the patient's caregiver and identifying the patients with similar treatment conditions using the weighted conditions in a nearest neighbor algorithm.

Patient information may be elicited by providing surveys to the patients to elicit the patient symptom data. The received data may be dynamically scored by the patient's caregiver to vary the weight afforded each patient symptom in evaluation of the patient's condition. The patient may also provide images and/or physiologic measurement data from the patient's smart phone or other processing device indicative of the patient's conditions or symptoms for storage in the database.

The invention also includes a system with a processor that processes instructions to implement the methods described herein as well as a computer readable storage device that stores instructions for implementing the methods described herein.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 illustrates a patient's browser (client) that contacts a web server that includes protocol builder software in accordance with an exemplary embodiment of the invention.

FIG. 2 illustrates a screenshot of an actual protocol for an exemplary patient.

FIG. 3 illustrates an input box that is used to create a new timeline by waiting for user input and reacting accordingly.

FIG. 4 illustrates the placement of events on the timeline of the input box.

FIG. 5 illustrates an exemplary flow of the protocol builder software and its management of user input.

FIG. 6 illustrates the events in the protocol ordered by type (Medications, Surveys, and Messages).

FIG. 7 illustrates all of the events in the protocol ordered visually by date (Medications, Surveys, and Messages).

FIG. 8 illustrates the information that is needed to prescribe a protocol to a patient.

FIG. 9 illustrates a screenshot of a graph displayed by the dynamic scoring system.

FIG. 10 illustrates how the protocol builder allows weighted scoring customization by the individual physicians.

FIG. 11 illustrates the screen that allows the user to log in.

FIG. 12 illustrates the initial account creation by collecting a username, email address, and password.

FIG. 13 illustrates the screen for prompting the user, upon login, to record phone greetings and to select protocols.

FIG. 14 illustrates the main patient selection screen.

FIG. 15 illustrates a screenshot in which the medications section is highlighted to illustrate how a user can search for medications or select a “favorite” medication from a custom list.

FIG. 16 illustrates that by clicking on a “favorite” medication or choosing a medication from a list the user may fill out the prescription data and assign the medication reminder to the patient.

FIG. 17 illustrates a screenshot in which the protocols section is highlighted to illustrate how protocols are organized into categories and then individual protocols.

FIG. 18 illustrates an individual protocol showing the medications, messages, and questions that the patient will be exposed to throughout the course of care.

FIG. 19 illustrates a screenshot in which clicking on the “General Data” section allows the user to enter patient preferences such as what time the patient would like to be called, how the patient should be contacted (text or phone), and when the protocol should start.

FIG. 20 illustrates a screenshot in which the active section is highlighted to illustrate how a user can enable, disable, or delete any active medications or protocols that have been assigned to the patient.

FIG. 21 illustrates that users can also display compliance for a particular patient medication.

FIG. 22 illustrates a screenshot showing how a patient interacts with the system via text message to take a survey.

FIG. 23 illustrates how each patient that was scheduled to be contacted during the current time interval is sent a message via the customized delivery method, either a phone call, a text message, or a smart phone application alert.

FIG. 24 illustrates how a phone call uses audio recordings to deliver pre-recorded messages and/or uses synthetic voices to read dynamic text.

FIG. 25 illustrates the patient's interaction with the web server using text messaging.

FIG. 26 illustrates the patient's interaction with the web server using an application alert that can only be sent to patients that have installed the corresponding app on his or her smart phone.

### DETAILED DESCRIPTION OF ILLUSTRATIVE EMBODIMENTS

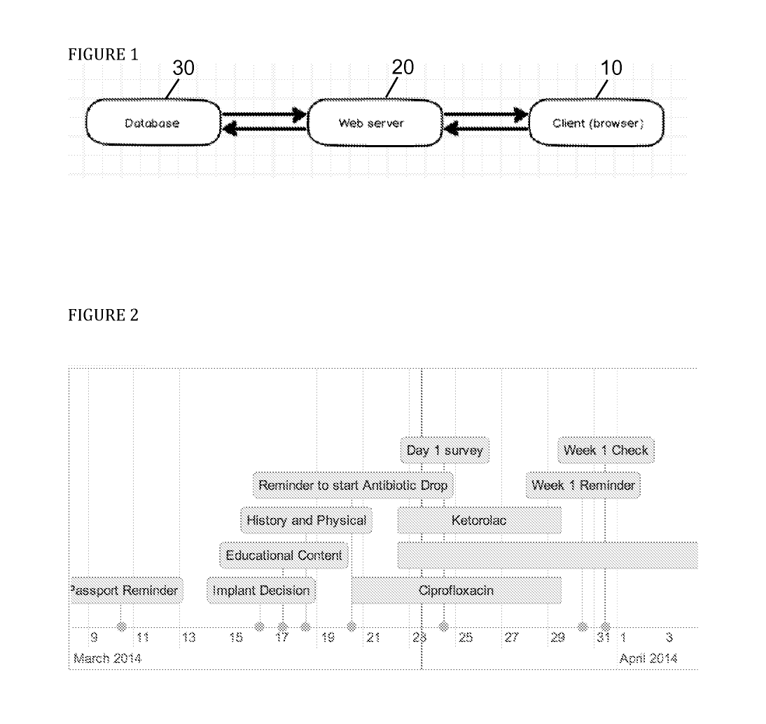

Certain specific details are set forth in the following description with respect to FIGS. 1-26 to provide a thorough understanding of various embodiments of the invention. Certain well-known details are not set forth in the following disclosure, however, to avoid unnecessarily obscuring the various embodiments of the invention. Those of ordinary skill in the relevant art will understand that they can practice other embodiments of the invention without one or more of the details described below. Also, while various methods are described with reference to steps and sequences in the following disclosure, the description is intended to provide a clear implementation of embodiments of the invention, and the steps and sequences of steps should not be taken as required to practice the invention.

### The Protocol Builder—Usage Description

The protocol builder of the invention covers all specialties of patient care, including cardiology, primary care, ophthalmology, and the like, and all levels of patient care, including hospital, nursing, home healthcare, office, and the like. In the most common use case, protocols are built to apply to a particular patient diagnosis or condition. For example, assume that Ms. Smith is a 70 year old patient with dense cataracts in both eyes. After her diagnosis, she is scheduled for surgery. In the traditional model of care, she would spend 30 minutes with a surgical coordinator discussing surgery. Her list of instructions on paper would include the following series of steps.

1. Identify and remember a surgical date

2. Complete pre op surveys on visual function for insurance approval

3. Complete online medical insurance forms 2 weeks before surgery

4. Complete a physical exam with primary care doctor

5. Identify and choose surgical options

6. Pick up and Start surgical medication

7. Plan transportation to hospital

8. Follow pre surgical preparation day before surgery

9. Follow post surgical instructions day of surgery

10. Follow post surgical instructions week after surgery

11. Understand post op warning signs

12. Remember post op appointment dates

13. Complete surveys on post op outcomes

In accordance with the invention, a protocol builder is provided through which each of these steps can be built into a software app on the clinician's device (iPad, phone, or other mobile processing device) to provide actual instructions, guidance, and monitoring in connection with the patient's cataracts diagnosis and disease management. For example, a patient, such as Ms. Smith, that is about to undergo cataract surgery could be contacted on her smart phone or other mobile processing device as follows:
2 weeks before surgery—A message reminding her to fill out all of the necessary surgical forms;
1 week before surgery—An educational email containing factual information pertaining to the upcoming procedure;
3 days before surgery—A baseline outcomes survey asking the patient how she feels prior to surgery;
The night before surgery—A message reminding the patient not to eat; and
Two weeks after surgery—A second outcomes survey asking the patient how she feels following surgery.

Present protocols for cataract surgery, for example, actually have over 100 points of patient communication for tracking and monitoring over a 90 day surgical period. The protocol builder described herein manages these communications and also includes the use of every individual physician's voice to be delivered to the treated patient when delivering care instructions. This is only one example of a clinical process. Those skilled in the art will appreciate that numerous other examples of clinical processes may be used in the context of the system and method described below.

At the outset, it is noted that the patient protocols described herein are not limited to patients with particular disease states. On the contrary, a doctor may prescribe a protocol to a perfectly healthy patient that contacts the patient at the appropriate time to schedule a routine checkup. Outside of the medical space, the invention may also be used to build protocols to help people prepare for trips, get in better shape, buy a house, or plant a garden. Such applications will be apparent to those skilled in the art from the following detailed description of the underlying technology of the protocol builder.

### Protocol Builder—Technology

In an exemplary embodiment, the protocol builder is a software application that is accessed via a website or phone app. For example, as shown in FIG. 1, a patient's browser (client) 10 contacts a web server 20 that includes protocol builder software in accordance with an exemplary embodiment of the invention. In the exemplary embodiment, the majority of the code for the protocol builder is written in JavaScript, with PHP running on the web server 20. The protocol builder software also accesses a MySQL database 30 to store and maintain the data used in the protocols.

Top-Level View of the Protocol Builder

In an exemplary embodiment, the protocol builder software running on web server 20 maintains data for managing a patient's condition by establishing a timeline for the patient. In the context of a patient surgery, for example, the timeline includes an anchor date that is a one-time event (e.g., surgery date) as well as periodic events (e.g., medication reminders) in a timelines for a particular patient and/or clinical case.

For example, in case 1, Mr. Jones is a 60 year old brittle diabetic who has been on insulin for 30 years. His endocrine doctor has been managing care with daily blood sugar checks and intensive diet management. Poor circulation requires a procedure with a foot doctor for care of a wound and then multiple follow up visits with a home nurse. With the protocol builder of the invention, the anchor date can be the date of diagnosis or the date of surgery. One-time events can be the dates of patient care visits between the endocrine doctor, foot specialist, and home nurse. The periodic events are daily medicine reminders, diet monitoring, and blood sugar checks. The timeline, anchor date, one-time event and periodic events allow the creation of all care plans.

As a further example, in case 2, Ms. Smith is examined on Feb. 20, 2014. Ms. Smith is a 70 year old patient with cataracts who chooses to have her right cataract removed. Her surgery is scheduled for Mar. 23, 2014. FIG. 2 is a screenshot of an actual protocol for Ms. Smith. As illustrated, a protocol is generated that is unique to Ms. Smith. A week before her surgery (March 16), she is prompted to provide an implant decision. On March 17, Ms. Smith is provided with educational content that is pushed to her smart phone or other mobile processing device, and Ms. Smith is prompted for her medical history and physical information on March 18. Ms. Smith is reminded to start her antibiotic drops on March 20 and is given periodic reminders to take her medications (Ciprofloxacin and Ketorolac) starting on March 20 and March 22, respectively. Ms. Smith is provided with a pre-operative survey on March 22 and a week 1 reminder and post-operative check on March 30-31. It will be appreciated that this timeline is built around the specific surgical event being provided to Ms. Smith as well as the specific medical characteristics of Ms. Smith.

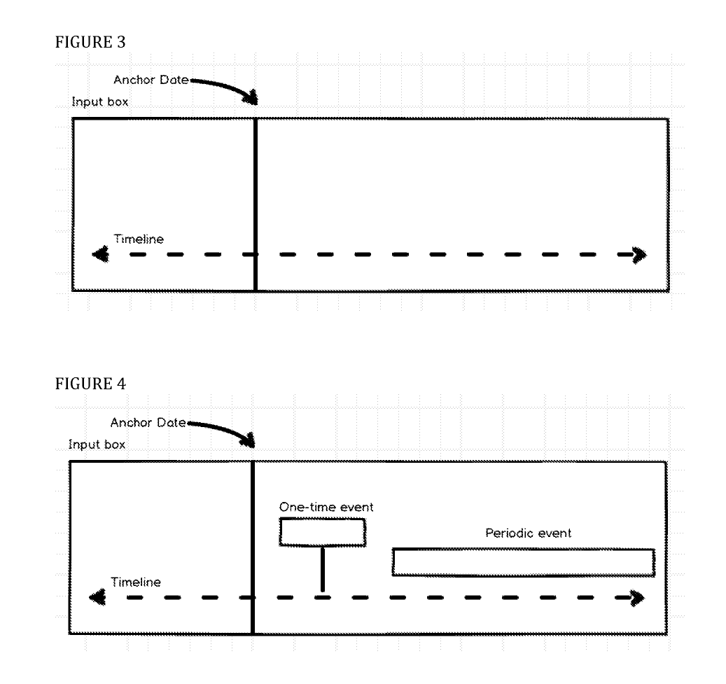

In order to create a protocol of the type illustrated in FIG. 2, the protocol builder software enables the user to create a new timeline by creating an input box (FIG. 3) that is the area of the screen that waits for user input and reacts accordingly. The timeline shows the user the scope of time being represented on the screen. This can be as short as milliseconds and as long as centuries. The anchor date is the date that provides a context for all of the events that are about to be scheduled in the patient's protocol. This anchor date typically represents the main event of the protocol being prescribed, such as the day of surgery or date of diagnosis.

The patient protocol also includes events. Events are types of communication (survey, message, or medication) that are scheduled to occur with the patient. As illustrated in FIG. 4, the protocol builder allows for two main types of events:
One-time events—Events that occur only once, at the time indicated on the timeline. Visually, these events are indicated with a line that comes down from the event name and connects to the timeline as shown in FIG. 4. The spot where the line hits indicates when the event is scheduled.
Periodic events—Events that occur on a periodic basis, over a set period of time. The frequency of the events can be adjusted to the user's preference. Visually, floating rectangles indicate these events as shown in FIG. 4. The left-most side of the rectangle indicates the start of the events, and the rightmost side of the rectangle indicates the end of the events.

Control Flow

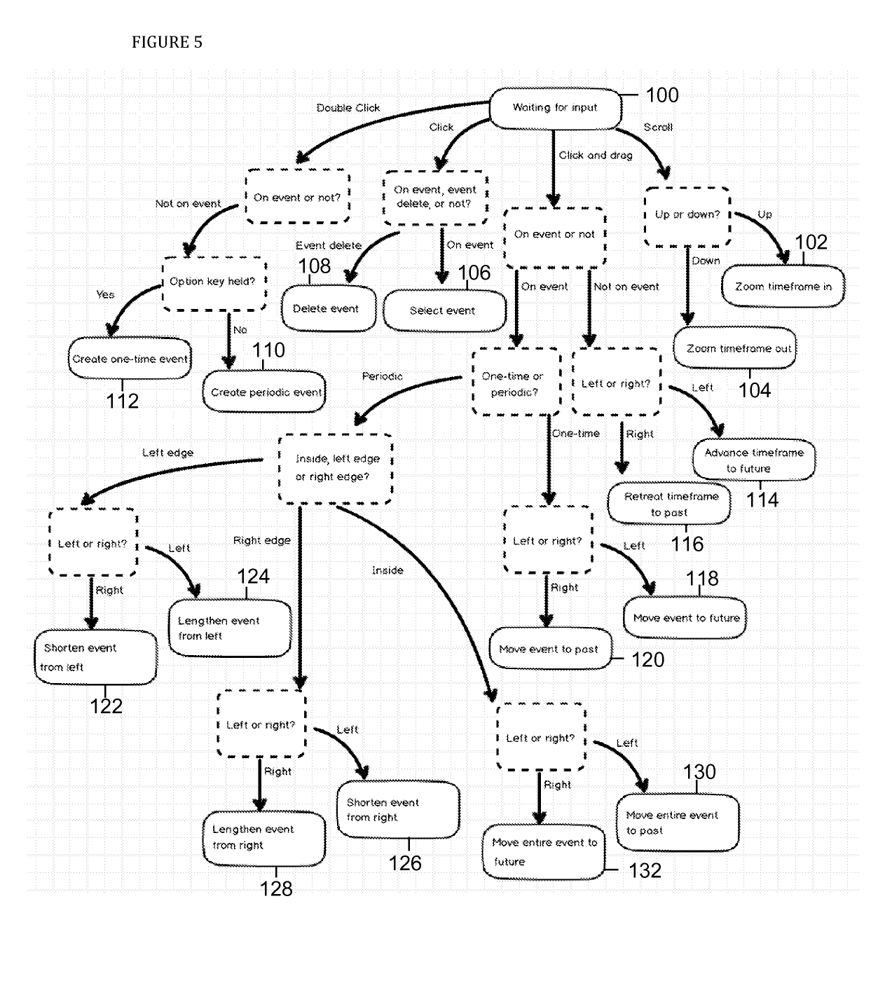

The protocol builder software creates the input box illustrated in FIGS. 3 and 4 and then waits for user input. Exemplary flow of the protocol builder software and its management of user input are illustrated in FIG. 5. As illustrated, the protocol builder software waits for input at step 100. If a scroll input is received, the timeframe zooms in for an up scroll at 102 and zooms out for a down scroll at 104. On the other hand, a single click on an event selects the event (106), while a single click on delete event deletes the event (108). A double click not on an event will create a periodic event (110) while a double click while an option key is held will create a one-time event (112). A click and drag that is not on an event will either advance the timeframe to the future (114) or retreat the time frame to the past (116). However, a click and drag on a one-time event will either move the event to the future (118) or the past (120). A click and drag on the inside left edge of a periodic event will either shorten the event from the left (122) or lengthen the event from the left (124), while a click and drag on the inside right edge of a periodic event will either shorten the event from the right (126) or lengthen the event from the right (128). Finally, a click and drag inside the periodic event will either move the entire event to the past (130) or to the future (132). Using these functions, the user builds protocols of the type illustrated in FIG. 2.

Database Structure

The database 30 (FIG. 1) contains a number of tables to facilitate the protocol builder. Only key fields will be described herein for the sake of brevity. As will be apparent from the following description, the structural design of database 30 allows care providers and patients to be compared in real time against normative outcomes and disease specific outcomes.

### Case Example:

Three practicing physicians in separate regions of the country are caring for 40 year old, obese sleep apnea patients. All of the patients are on nasal oxygen and use breath machines at night. Based on the seasonal temperature, weight loss, and geography, their response to nebulizer treatment may vary. The design of database 30 allows all providers to compare oxygen requirement against all the non-sleep apnea patients with lung disease in the local geography against their patient. It also allows comparisons in real-time against all other sleep apnea patients across the country with the same medications, age, co-morbidities and geography. Individual providers can also compare their effectiveness of care against each other.

For such purposes, the database 30 includes a Protocols table that stores all of the metadata associated with each protocol, including:
Protocol name—The name of the protocol;
Protocol category—The type of protocol (surgical, monitoring, etc.).
   The database 30 also includes a ProtocolEvents table that stores the events that are associated with a particular protocol, including:
Protocol event name—The name of the event;
Start Date—Relative to the anchor date, when the event starts;
End Date—Relative to the anchor date, when the event ends (only used for periodic events).
   The database 30 further includes a ProtocolEventsToComms table that stores for each event in ProtocolEvents the type of communication that should take place, including:
Communication type—Whether this event is a message, survey, medication, or email;
Communication ID—In the respective communication specific tables, the ID of the particular event that should be linked.

The database 30 further stores Surveys, SurveyQuestions, and SurveyAnswers tables. This group of tables organizes all of the surveys that are asked as a particular event:
Question—The question that should be asked;
Question representation (text, phone, app)—How the questions should be asked via each communication method;
Answers—The answers for each question;
Answer representation (text, phone, app)—How the answers should be represented via each communication method.
   The database 30 also includes a Message table that organizes how messages should be represented to patients, including:
Message—The message that should be communicated to the patient;
Message representation (text, phone, app)—How the message should be represented via each communication method.
   The database 30 further includes a ProtocolMedications table that organizes how medications, included as part of a protocol, should be represented to patients, including:
Medication type—The type of medication being taken by the patient;
Take type—The number format of the medication (i.e., 2 pills);
Dose—The dosage of medication;
Frequency—How often the patient should take the medication;
Default take time—When the patients should be reminded to take the medications.
   The database 30 may also include an Emails table that organizes how emails should be represented to patients, including:
Subject—The subject of the email;
Body—The body of the email.

Miscellaneous Information Stored in Database

The database 30 may also store miscellaneous information such as recording questions and messages, where each question and message has an area that allows the user to make a voice recording of that particular text. This recording is then played when patients are called on the phone. Also, care providers also record a “welcome” message that is the first thing patients hear when they answer the phone. For example: “Hello, this is Dr. Williams calling to remind you to take your medications.” This function enables every care provider and patient to maintain a unique and customized patient-provider relationship. The patients hear their own care provider's unique voice which improves compliance and adherence to protocol while minimizing patients who cancel the care program.

In addition, the system may include miscellaneous features including:
Automatic saving—The user is never asked to click a “save” button. All actions are sent back to the server and the database is immediate updated.
Colored events—Different events are colored in different ways to make it easier for the user to distinguish them.
Text/touch interface—As described in the “Control Flow” section, a user may manipulate events via the Input box. Users may also manipulate events via text boxes shown below the Input box.

Prescribing Protocols

Once created, a protocol can be prescribed to any patient by a physician via an app. This app is HIPAA compliant—all information that is sent from the app to the web server is encrypted, all traffic is logged to allow for information auditing, and the app requires a user name and password to use. As an example, Dr. Marsh is a busy pediatrician. During cold and flu season he sees 40 patients a day but 25 of the children will present with the identical symptoms and receive the same preferred treatment approach. The protocol builder enables the physician to establish a protocol that is a “best of care” approach that can be designed to the specifications of an individual physician and applied to all 25 patients. Even if the medicine is changed or the dosage altered, the protocol can quickly be assigned once the initial protocol design is approved. Also, each time the protocol is assigned, the physician verifies that the medicine and dosing and protocol recommendations are correct for that patient.

The following information is needed in order to establish such a protocol:
Anchor Date—This tells the system what date all events should be based off of. Note—the anchor date is not necessarily the start of the protocol. For many protocols (such as surgery), there are events that occur both before and after the anchor date.
Method of Contact—This gives the patient the choice of being contacted via phone calls, text messages, or through a smartphone app.
Time of Contact—This gives the patient the choice of what time the contact for messages and surveys should occur.
Phone number—How to reach the patient for call and text message contact.
   In addition to these basics, users are also required to confirm the medications and their properties (dosage, type, etc.) prior to prescribing a protocol. This ensures that no medications or medication properties are incorrectly assigned automatically. Typically, protocols are assigned via a tablet or smartphone app administered by a clinician.

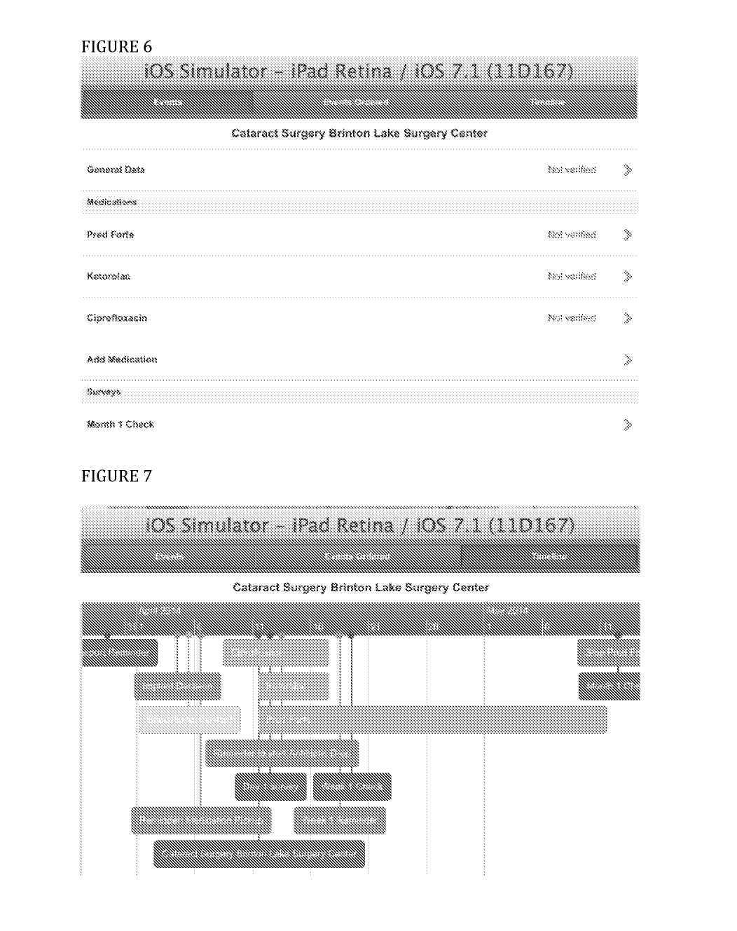

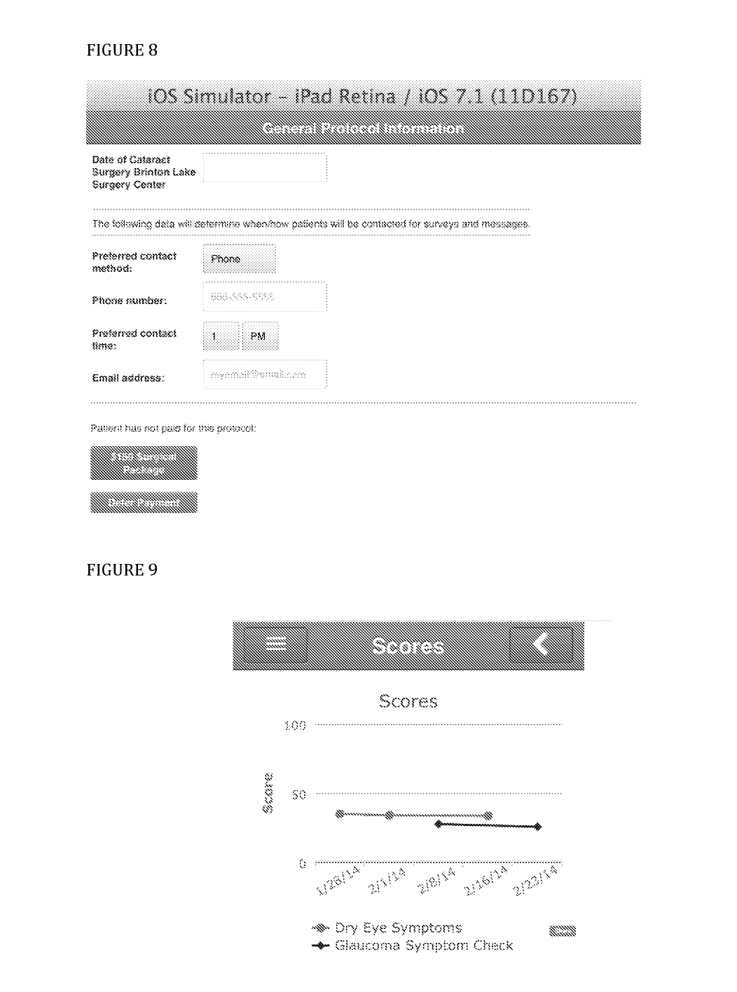

FIGS. 6-8 illustrate screenshots representing what the interface looks like for the protocol prescription app for a protocol established for the following patient: Ms. Fox an 80 year old patient scheduled for cataract surgery on Apr. 12, 2014. She is to have cataract surgery with implant of a new implant. Her medications are Ciprofloxacin, Pred Forte and Ketorolac. The surgery will be preformed at Brinton Lake Surgery Center. FIG. 6 illustrates the events in the protocol ordered by type (Medications, Surveys, and Messages), while FIG. 7 illustrates all of the events in the protocol ordered visually by date (Medications, Surveys, and Messages). FIG. 8 illustrates the information that is needed to prescribe a protocol to a patient.

Database Structure for Prescribed Protocols

The database for prescribed protocols includes the following fields (only key fields are included for the sake of brevity):

ScheduledProtocols stores all of the metadata associated with each prescribed protocol, including:
PatientID—Which patient the protocol is assigned to;
Anchor Date—As described above;
Method of Contact—As described above;
Time of Contact—As described above; Phone number—As described above;
Email—The email address of the patient if given.

ScheduledProtocolEvents stores the information for each particular event associated with an assigned protocol, including:
Event ID—The event (survey, message, medication, email) that should occur on the calculated date;
Calculated Contact Date—The date that the contact should occur. This event is calculated relative to the anchor date.

Calculating the Contact Dates

An algorithm calculates the contact dates for each protocol event by grabbing the selected protocol from the database 30 and, for each event associated with the selected protocol, adds the events “days relative to the anchor date” to the given anchor date and stores the resulting date into ScheduledProtocolEvents.

Dynamic Scoring—Usage Description

The protocol builder also receives patient feedback through surveys. The questions asked can relate to any topic, but are typically centered on health status, satisfaction, or marketing issues. When assigning an overall score to a set of questions, different users may value certain questions more than others. For example, suppose three physicians are monitoring the improvement of patients with dry eye using a survey.
Physician A feels that a patient's pain levels are the most important indicator of improvement;
Physician B feels that a patient's eye redness is the most important indicator of improvement;
Physician C feels that a patient's general satisfaction level is the most important indicator of improvement.
   The protocol builder system allows each particular doctor to assign relative weights to each question to customize the scoring. This is done via a set of sliders situated below each question. The results are represented in a graph that shows the scores over time.

Interface of Dynamic Scoring

To illustrate the dynamic scoring, assume Ms. Wilson is a 50 year old patient with severe dry eyes. For the past 2 years, she has been treated with artificial tears, antibiotic ointment and Restasis drops. Her symptoms are pain, itching, tearing, blurred vision, sensitivity to light and heaviness of her eyelids. The protocol builder allows Ms. Wilson's symptoms and medications to be tracked in real time on a daily, weekly or monthly basis by a physician. Assessment of individual symptoms (variables) allows a deeper understanding of the disease process and disease cycle. The patient may be examined by different providers, who feel one or more symptoms is the best indicator of the state of disease. This dynamic scoring system enables this possibility. FIG. 9 is a screenshot of a graph displayed by the dynamic scoring system.

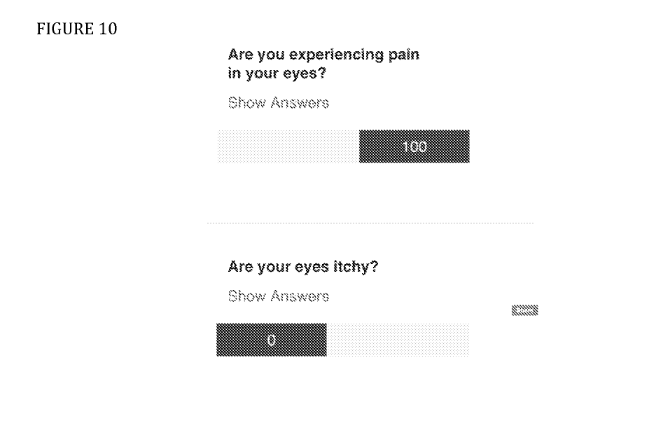

FIG. 10 illustrates how the protocol builder allows weighted scoring customization by the individual physicians. To change the relative weights of a particular question as it pertains to scoring, a user simply drags the slider. Once the slider is released, the patient's survey scores are recalculated and the graph is updated. Both the clinician's preferences and the updated survey scores are automatically saved to the database. This application may be presented to users via a touchscreen app. However, this system also may be presented via a website.

### The Scoring Algorithm

In the following formula, for each question x, NormalScore_x is calculated as follows (in this case, for the first question):

NormalScore_{—}1=(ScoreQuestion_{—}1/MaxScoreQuestion_{—}1)

ScoreQuestion_1 is the numerical score assigned to the answer that the patient chose for question 1 and MaxScoreQuestion_1 is the highest possible score that the patient could achieve. Using this value for each question, the overall score is calculated as follows

$$OverallScore = \frac{NormalScore\_ 1 * Weight\_ 1 + NormalScore\_ 2 * Weight\_ 2 …}{Weight\_ 1 + Weight\_ 2 …}$$

FinalScore=OverallScore*100

Weight_x is the value (from 0 to 100) that each question is given by the user using the weighted sliders. All question weights start at a default of value 1. Setting a question weight to 0 removes its influence from the scoring algorithm entirely. A question with a weight that is 2× other questions will be weighted approximately 2× more than the other questions. The final result is normalized and then scaled by 100 to achieve the final score. Of course, other weighting formulas may be used.

Database Structure for the Dynamic Scoring Section

The database for the dynamic scoring section includes the following fields (only key fields are included for the sake of brevity):

SurveyQuestionsScoring—This table holds the desired question weights for a particular user, including:
UserID—The user;
QuestionID—The question;
Question Weight—A value from 0-100 indicating the weight that the user choose for that particular question.

SurveyAnswersScoring—This table holds the desired answer weights for a particular user for each answer to a question, including:
UserID—The user;
AnswerID—The answer;
Answer Weight—Any number indicating the value that the user choose for that particular answer.

Predictive Aspects

Over time, the protocol builder database 30 collects records for many patients. Within a short period of time, the protocol builder database will include millions of the following types of records:
Medication adherence statistics—Which patients took their medications, what type of medications were taken, and when they were taken;
Patient outcomes scores—Patient health improvement measured via surveys asked to the patients;
Patient medical history—Relevant patient health information, taken from sources such as the hospital/practice EMR system.
   By analyzing these information sources, the protocol builder software will be able to aid the clinician in a number of different ways, including:
Medication adherence—Each time a physician prescribes a new medication to a patient with the protocol builder, the system could profile that patient to determine the likelihood that the patient will be compliant with his or her medications. The system would look back across all past patients for similar patient profiles, note the average compliance level of those past patients, and then represent that number to the doctor. For those patients that are unlikely to be adherent, the physician could spend some extra time explaining the importance of taking medications.
Likely patient outcome—A doctor could import a patient's medical history, enter the patient's diagnosis, and input any other relevant information. The protocol builder software would take that data and return a graph showing how similar patients were treated in the past and how those patients improved over time. For example, suppose that a 68-year-old female patient with diabetes is diagnosed with glaucoma. The protocol builder database contains 10,000 patients, all treated in the past, which roughly match this patient profile. Of those 10,000 patients, 50% were treated with “Drug A,” 30% with “Drug B,” and 20% with “Drug C.” The protocol builder system would display, in a graphical format, the “improvement curves” of each set of patients for the physician to examine Information such as drug cost, side effects, and other patient/clinician comments would also be indicated alongside these curves. Ultimately, based on this information, the physician would be able to prescribe the drug best suited for his/her patient.
Predicting complications and side effects—Most protocols include “symptom surveys.” These surveys ask patients about their current medical state—how much pain they are in, if their eyes are itchy, etc. Each time that a symptom survey is filled out by a patient, the protocol builder software can look for patterns and variations that match previous patients' responses in the database. If the system senses that a likely complication is coming, the patient and doctor can be notified that medical treatment is needed immediately. For example, suppose that a patient that has just been released from the hospital for pneumonia indicates that he is beginning to feel light headed. The protocol builder software can look across similar patients treated for pneumonia in the past, determine that feeling lightheaded has never lead to any further problems, and not raise any alarms. One week later, however, the patient indicates that they have also begun to lose weight. When the system looks at previous pneumonia patients that are both light headed and losing weight, it sees that 50% of them were readmitted to the hospital within 2 weeks. Thus, it sends an alert to both the patient and his doctor indicating the possibility of a potential readmission.

Interface of the Predictive System

A “Predictive” tab is provided for the user to select. This tab will take the user to a section that contains the following information:

1. Classification data—The information that is being used to classify the currently selected patient. This could be data like medications, diagnosis, or certain aspects of medical history. If the protocol builder software needs more information to classify the patient, the doctor will be informed about what data needs to be entered.

2. Similar patients—The system will indicate to the physician the number, type, and matching characteristics of patients in the database that it believes are “similar” to the current patient being studied. The physician will have the option of modifying these criteria in order to refine the subset of patients being used for predictive purposes. This set of patients will be known as the “patient prediction pool.”

3. Predictive graph—A graph will be shown that displays the improvement curves of the patient prediction pool, separated by how those patients responded to different treatment types. These curves will be the average scores calculated from symptom surveys taken in the past.

4. Likely complications—The system will also return a list of the most common complications that the patient prediction pool has experienced.

5. Most likely patient improvement curve—Once a treatment has been inputted for a particular patient (medication/protocol prescribed, etc.), the system will display a drop box that contains all the different questions that past patients in the patient prediction pool undergoing the same treatment have been asked. When a particular question is selected, the system will show a graph representing average improvement for that question for all similar patients undergoing the same treatment.

To illustrate this interface description with an example, suppose that the 68-year-old diabetic patient with glaucoma is being analyzed using the predictive feature of the protocol builder software. In the first section, the system lists the fact that it is using her age, gender, diabetes, and glaucoma diagnosis as the classifiers. In the second section, the system indicates that it is returning 9,849 patients that are also female diabetic patients, diagnosed with glaucoma, between the ages of 65 and 75 (the doctor may remove or adjust any of these factors). In the third section, the system shows a graph indicating how 5,000 patients improved over 1 year after being given “Drug A,” how 3,000 patients improved over 1 year after being given “Drug B,” and how the remaining 2,000 or so patients improved after being given “Drug C.” Finally, the system lists possible complications experienced by all 10,000 past patients below the graph. If the doctor then decides that he is going to prescribe “Drug B” to the patient, a final graph appears showing the average change in pain levels; eye redness, blurriness, and itchiness; change in vision; and change in ocular pressure for all patients that were given “Drug B.” The doctor can take the patient through these questions and graphs to show her what to expect over the next year of treatment.

Implementation of the Predictive System

To start, the system will present a list of patient classifiers to the doctors asking them to indicate which pieces of patient information are relevant to predicting patient care. Given the input of many doctors, the system will begin assigning weights to each of these classifiers (age is worth a lot, diabetes is worth a lot, hair color is worth nothing, etc.). Many algorithms exist for matching input data (the current patient being treated) to a set of already defined data points (the past patients). Using the varying weights inputted by the doctors, the system uses a “nearest neighbor” algorithm to return a set of patients that are similar to the patient being treated. Basically, the system assigns scores to each patient, with the score being the sum of the weight of each classifier times a percentage (between 0 and 1) that measures how close the current patient's classifier is to the past patients being considered. Only those past patients that exceed a certain score will be return as “matching” patients.

For example, suppose that we are searching for patients that are similar to the 68-year-old diabetic patient with glaucoma. Via the input of thousands of doctors, the system has the following weights assigned to each of her classifiers (where a weight of 0 indicates no relevance and a weight of 100 indicates critical relevance):
Glaucoma—100
Gender—20
Diabetes—70
Age—50
   The system considers two patients that might be “similar” to this patient. The first is a female patient, age 50, without diabetes or glaucoma:

Resulting score is (0*100(Glaucoma Weight))+(1*20(Gender Weight))+(0*70(Diabetes Weight))+(0.1*50(Glaucoma Weight))=25

This indicates that both patients share some similarities (both are female and above the age of 50) but do not share many other characteristics.

Now if the system looks at a male patient, age 65, with diabetes and glaucoma:

Resulting score is (1*100(Glaucoma Weight))+(0*20(Gender Weight))+(1*70(Diabetes Weight))+(0.9*50(Glaucoma Weight))=215

Even thought this patient is male, he has glaucoma, diabetes, and is very close in ago to the target patient. Since his score is over 200, he is returned as a patient that should be involved in the prediction process.

### Protocol Builder User Interface

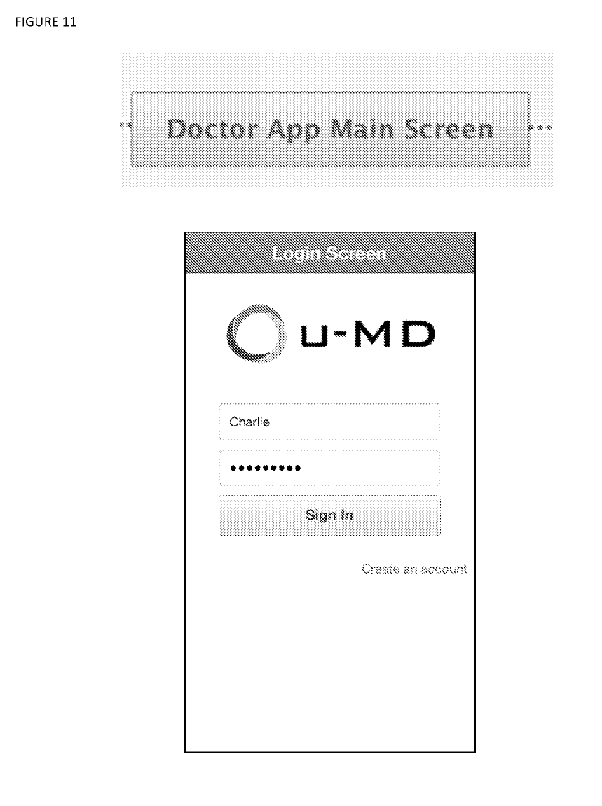

FIGS. 11-22 illustrate interfaces through which the user (typically the physician or nurse) interfaces with the protocol builder software (called u-MD in the figures) to build patient protocols as described above.

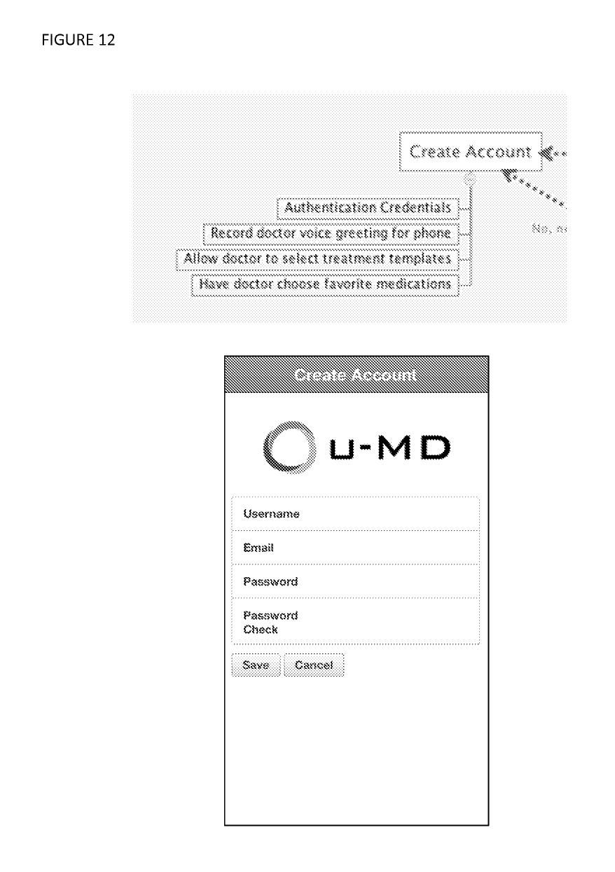

FIG. 11 illustrates the screen that allows the user to log in. If the user does not have an account, he or she can click “Create an account” to get started. FIG. 12 illustrates the initial account creation by collecting a username, email address, and password.

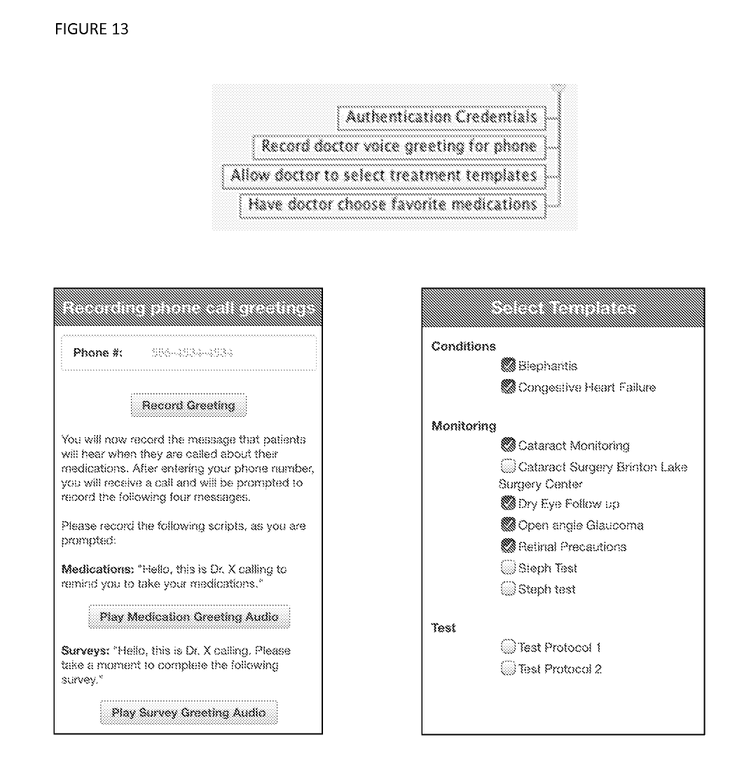

As shown in FIG. 13, upon login, the user (doctor or nurse) is prompted to record phone greetings and to select protocols. As desired, the user records phone greetings or selects the boxes for the desired protocols.

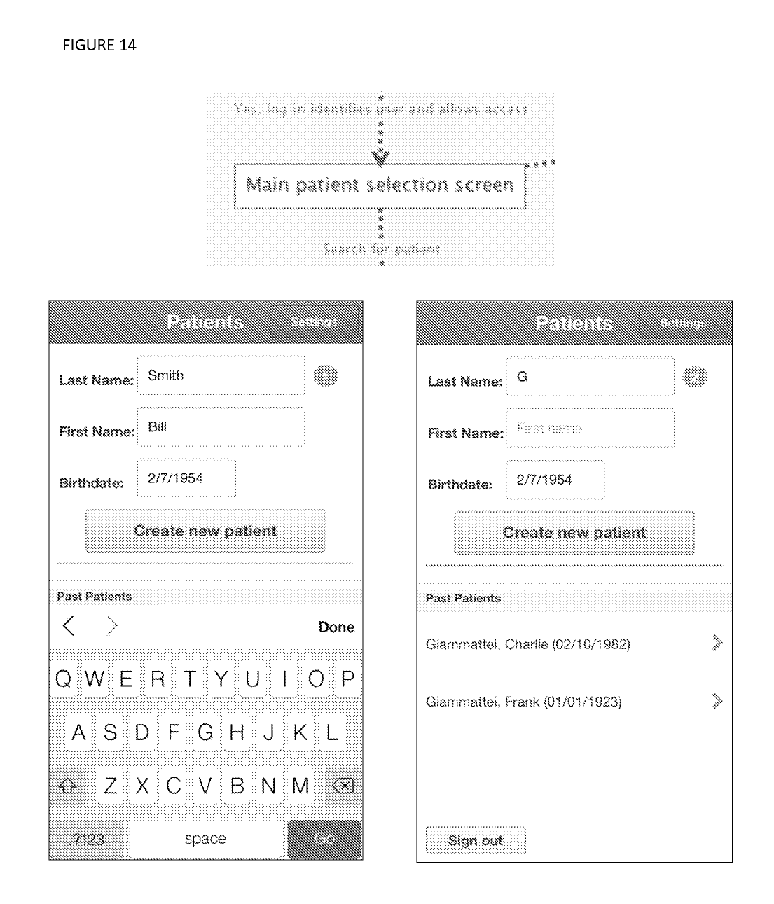

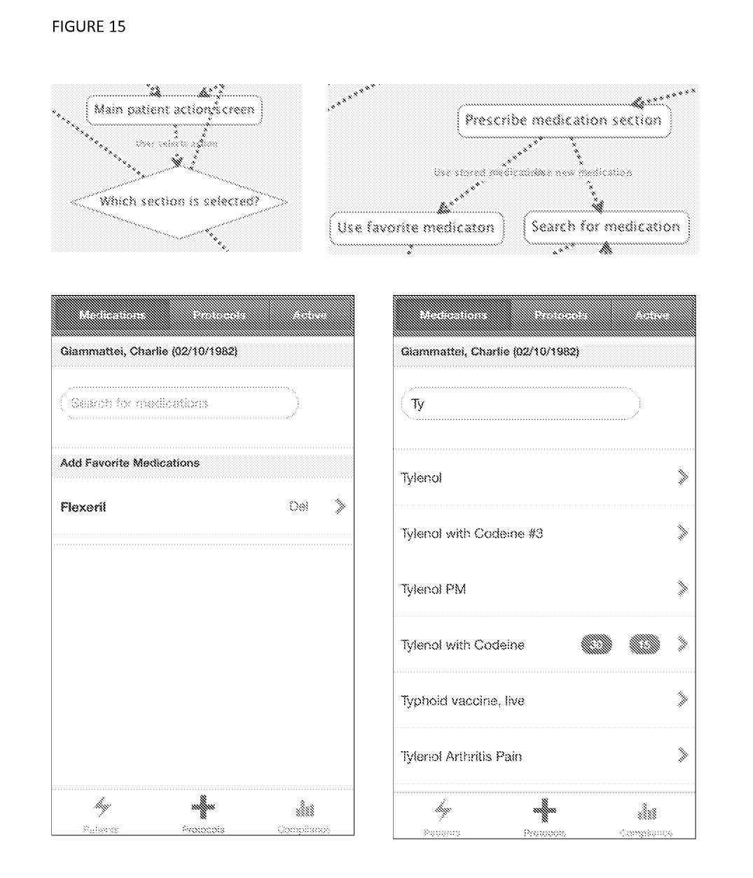

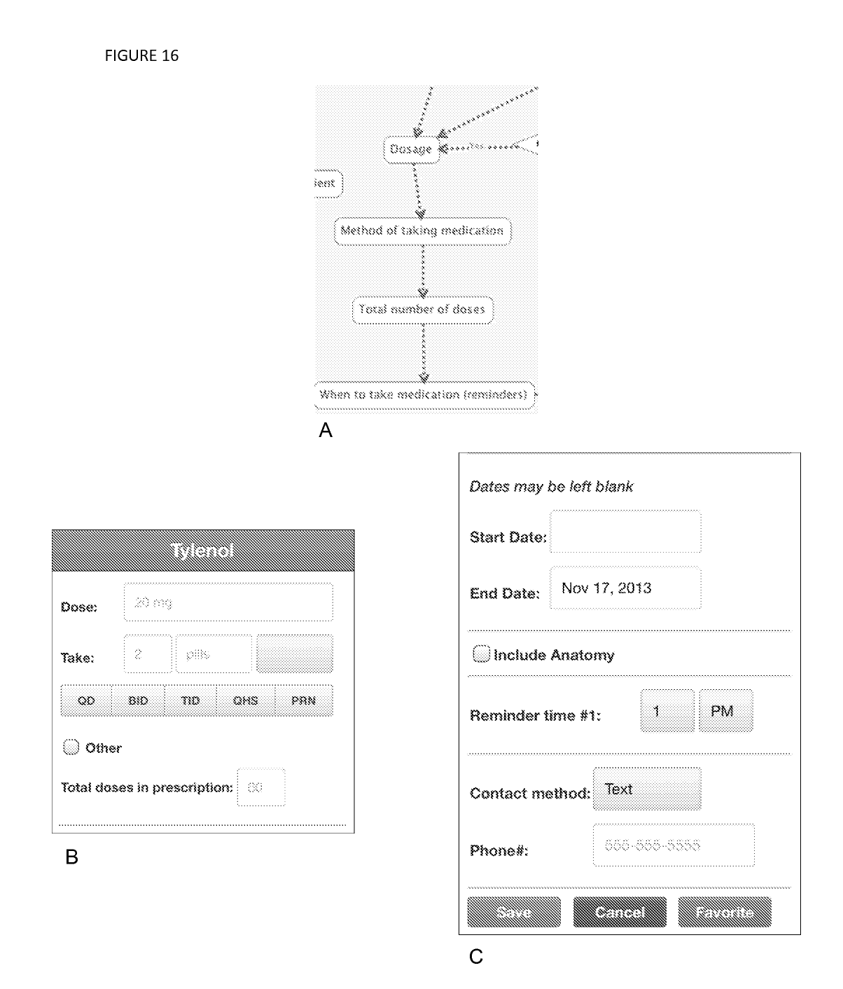

FIG. 14 illustrates the main patient selection screen. In the patient selection screen, a user can either create a new patient or search for a previously created patient. After creating or selecting a patient, the user has three options:
1) Create medication reminders for the patient (Medications);
2) Assign the patient to protocols (Protocols);
3) Modify active medication remind (Active).
   In the screenshot illustrated in FIG. 15, the medications section is highlighted. A user can search for medications or select a “favorite” medication from a custom list. Clicking on a “favorite” medication or choosing a medication from a list allows the user to fill out the prescription data and assign the medication reminder to the patient as shown in FIG. 16.

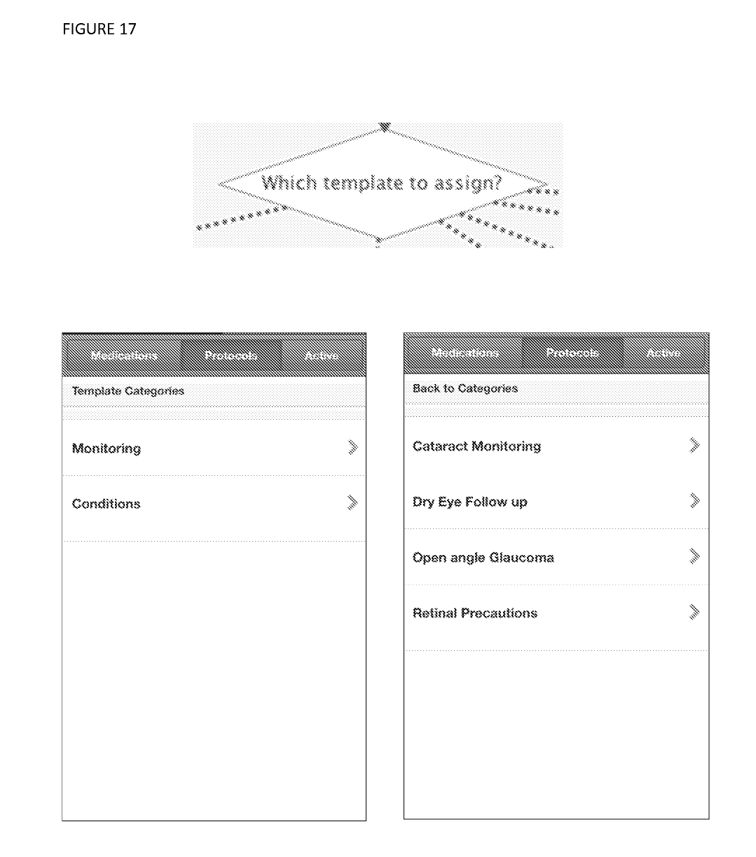

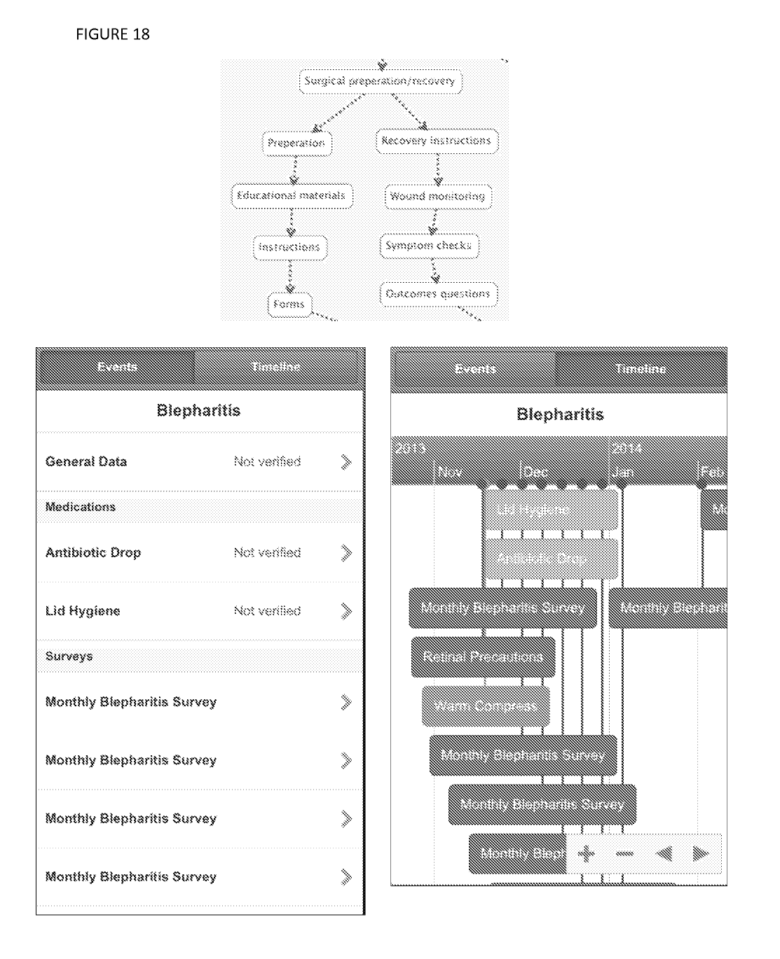

In the screenshot illustrated in FIG. 17, the protocols section is highlighted. As illustrated in FIG. 17, protocols are organized into categories and then individual protocols. As shown in FIG. 18, selecting an individual protocol shows the medications, messages, and questions that the patient will be exposed to throughout the course of care. The “timeline” view in FIG. 18 allows the user to visually see the patient protocol.

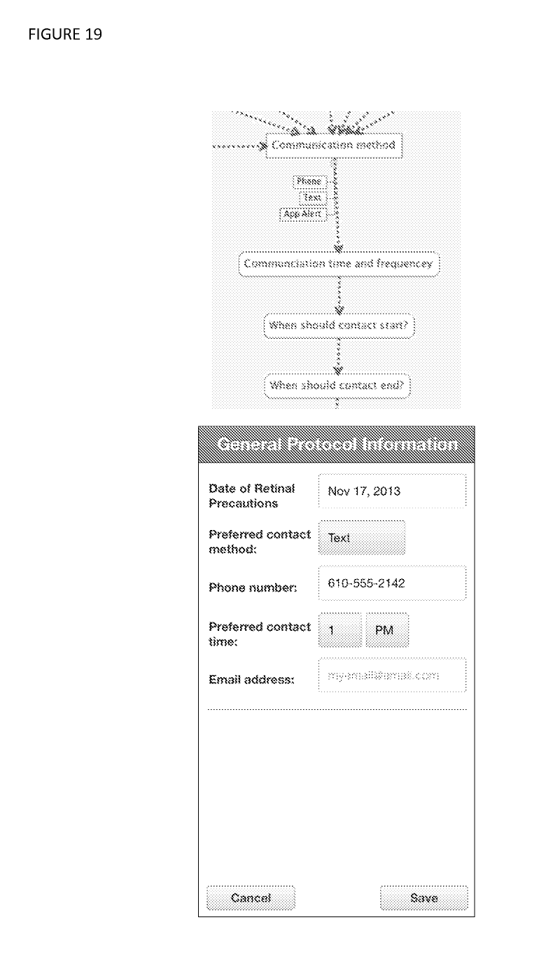

In the protocol section, clicking on the “General Data” section allows the user to enter patient preferences. As shown in FIG. 19, such preferences may include what time the patient would like to be called, how the patient should be contacted (text/phone/app), and when the protocol should start.

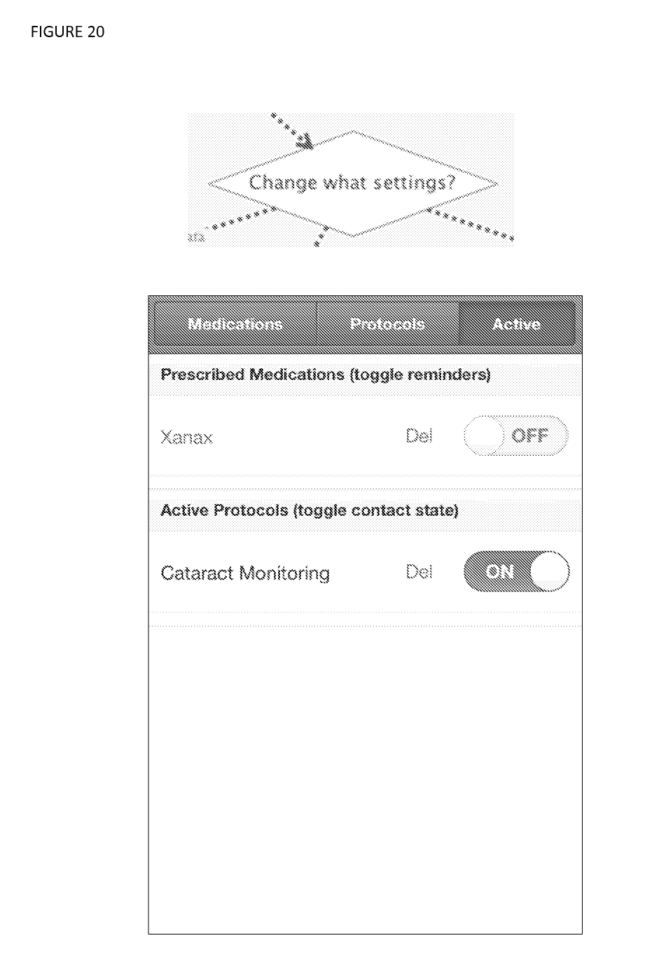

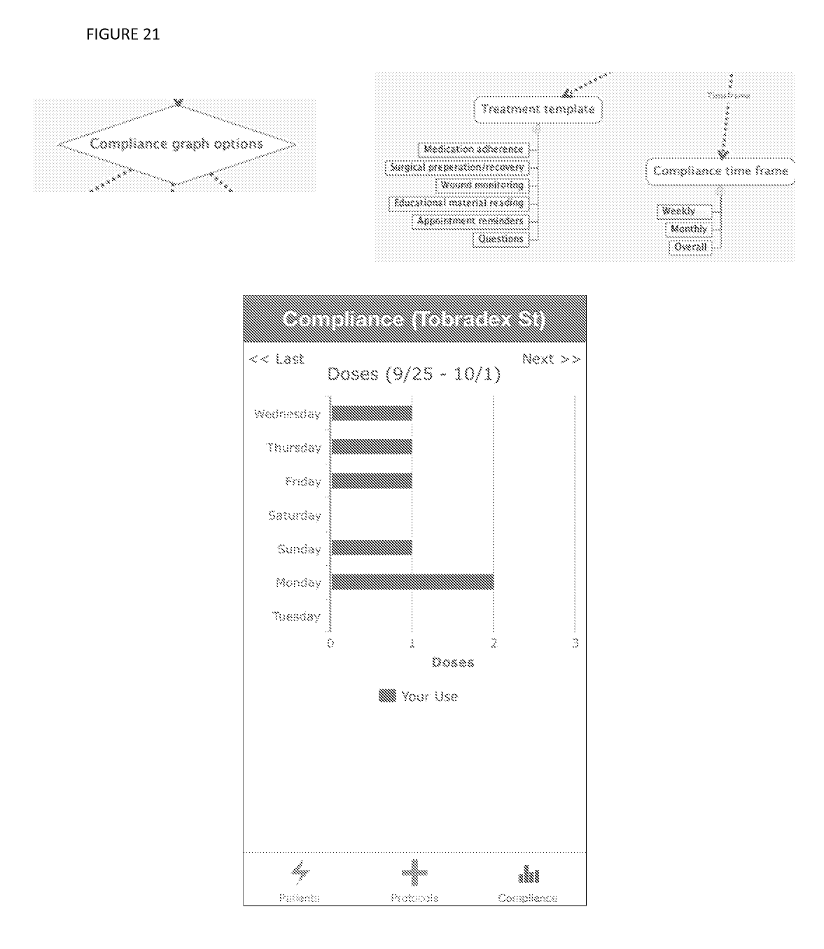

In the screenshot illustrated in FIG. 20, the active section is highlighted. In the “Active” section, a user can enable, disable, or delete any active medications or protocols that have been assigned to the patient. Also, as shown in FIG. 21, users can also display compliance for a particular patient medication. Compliance numbers can be viewed for any medication, and can be monitored weekly, monthly or over all time.

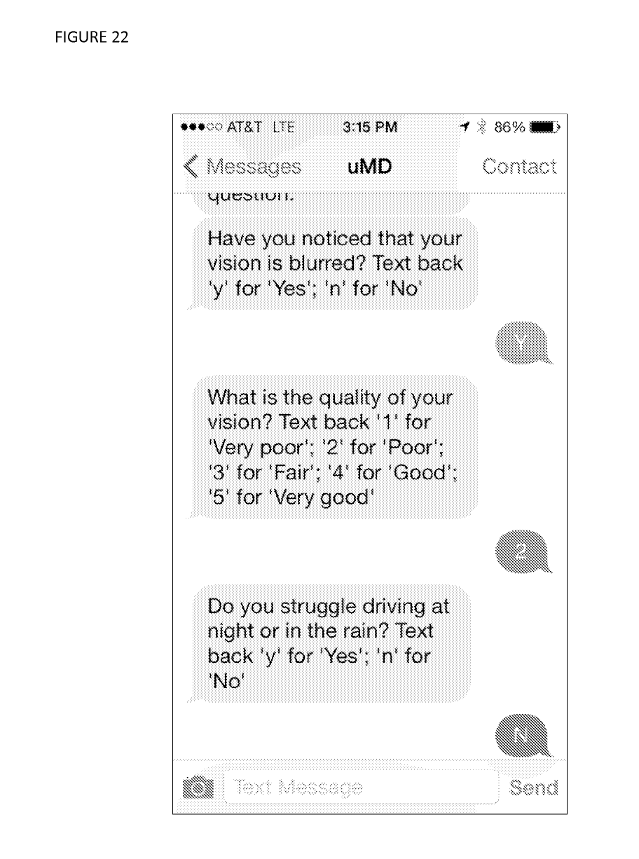

Finally, as illustrated in FIG. 22, medication reminders and protocols initiate either phone calls or text messages to a patient. The screenshot of FIG. 22 shows how a patient would interact with the system via text message to take a survey.

### Illustration of Server Operation

As illustrated in FIG. 1, the user (typically a doctor or nurse) interacts with the web server 20 including the protocol builder software via the user's browser 10. As noted above, the user may record a personal communication, schedule a patient contact, and the like. The inputted information is sent to the web server 20, which authenticates the user's device's request and records the information in the fields of database 30. This process if followed for many patients and protocols to build the database 30 as noted above.

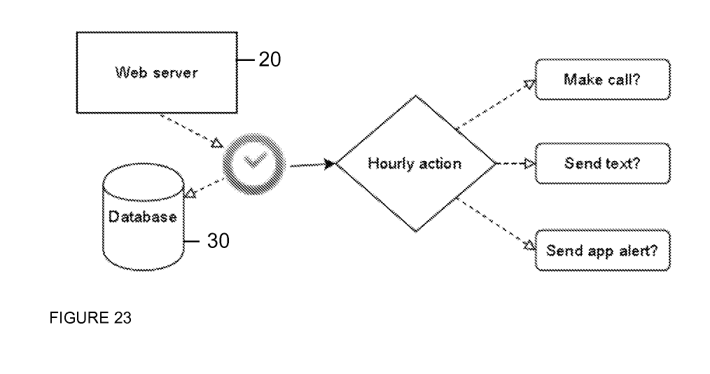

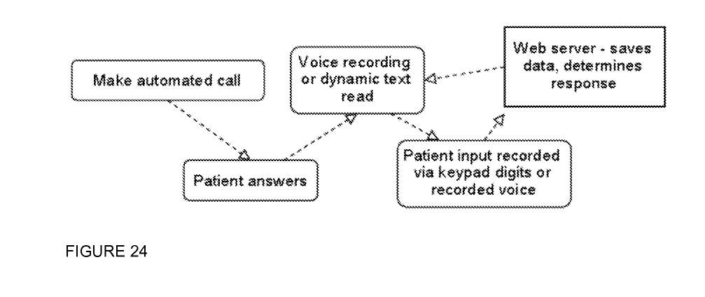

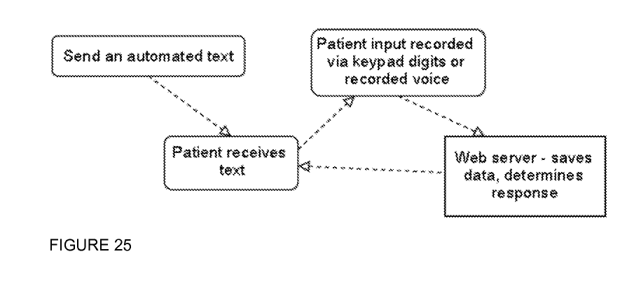

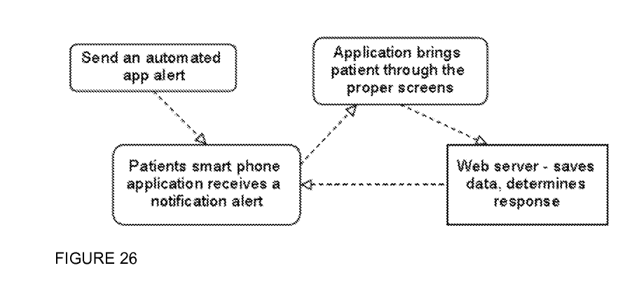

At periodic intervals, such as every hour, the web server 20 runs a “cron job” to determine which patient's have a scheduled communication during the upcoming time interval. As illustrated in FIG. 23, each patient that was scheduled to be contacted during the current time interval is then sent a message via the customized delivery method, either a phone call, a text message, or a smart phone application alert, for example. As illustrated in FIG. 24, a phone call uses audio recordings (preferably in the voice of the doctor or nurse) to deliver pre-recorded messages and/or uses synthetic voices to read dynamic text. Patients input data by pressing the proper phone digits or by recording responses. Based on the patient input, the server 20 determines the next action, including the audio that should be played for the patient, if the call should end, how to update the database 30, if an email should be sent, and the like. On the other hand, as illustrated in FIG. 25, a text message may contain plain text, URLs, or phone numbers. The patients input data by replying with a text message back to the web server 20. Based on the patient input, the web server 20 determines the next action, including if a text should be sent back to the patient, how to update the database 30, if an email should be sent, and the like. Finally, an application alert can only be sent to patients that have installed the corresponding app on his or her smart phone. As shown in FIG. 26, patients receive a notification from the application, prompting the patient to open it. Once opened, the application can collect data from the patient, give the patient instructions, or initiate other actions.

The operation of the patient app for interfacing with the protocol builder system is very straightforward. The patient app enables the patient to create a login account to establish the patient's system credentials. Upon login, the patient selects to either view his/her compliance with his/her assigned protocol, contacts the doctor, performs an action prescribed by the doctor, or performs some other action enabled by the system. The prescribed actions could include taking medication, taking photographs of a wound, etc. using the patient's smart phone, reviewing educational content, and the like. The resultant data would then be sent to the doctor. For example, the patient could send a short text message (Yes or No) indicating that the medication has (or has not) been taken. The database 30 would update its records accordingly. In addition, the patient's interaction with the system, including phone calls, could be recorded and stored in the database 30 as part of the patient's medical record. The stored voice or text could be imported as appropriate into the patient's Electronic Health Record.

When viewing compliance, the patient would be provided with data from the database 30 showing the recorded patient's actions in response to the requested activities. Any points of departure and the repercussions of same could be explained to the patient. The patient could also respond to surveys and the like as pushed to his/her smartphone. The survey results could be put in graph format for interpretation by the doctor or nurse. Typically, the questions would ask about disease symptoms that allow the doctor or nurse to understand the progression of the disease and its impact on the patient's daily living. These data points allow the doctor or nurse to make data driven treatment decisions based on many points of data over time as opposed to the few data points that the doctor or nurse receives when the patient is in the doctor's office. This survey also allows the doctor or nurse to monitor in real time through survey questions whether the patient is suffering any medication side effects for a faster response to reverse such effects.

### ALTERNATIVE EMBODIMENTS

In alternative embodiments, attachments may be provided for the patient's smart phone to enhance the data capture from the patient in between doctor visits. For example, depending upon the patient's condition and ability to handle the attachment, the patient may be provided with a cellular ophthalmoscope for imaging the eye, a cellular dermatoscope for imaging the skin, a cellular laryngoscope for imaging the throat, a cellular otoscope for imaging the auditory canal, a cellular stethoscope for recording a physiologic tone, an endoscope attachment for internal examination of oral, nasal, and respiratory tract. A cellular peak flow meter may also be provided to record peak lung flow for monitoring asthma, COPD, reactive airway disease, and the like. A self-examination scope may also be provided as a front mounted microscope attachment that allows self-examination of facial structures by the user.

Those skilled in the art will further appreciate that the system described herein may be modified to work with a drug dispensing device to remotely control the patient's drug delivery by enabling 24/7 access to medication for dispensing and drug compliance. The medications could be carried with the patient's smart phone for dosing, tracking and alerting the patient when it is time to take a medication. The protocol alerts may also be used to alert the patient to take non medical aerosol and liquid dispensing items or energy boost supplements, and to use an epi-pen, an asthma inhaler, get a caffeine or a sugar boost, and the like.

The patient's smart phone may also be replaced by a universal cell phone examination device (UCPED) including a biosensor device used to record physiologic data for examination and diagnosis. Such a device leverages the power of commercially available cell phones or i-pads and enables the reversible adaption of the cellular device for home or clinically use. The UCPED is designed around reversibly connecting biosensors to the central case housing. The molded central casing holds the cellular device and positions male/female attachment ports over the microphone and camera of the device. Attachments over the microphone allow recording of an audible physiologic tone. A stethoscope and a peak air flow meter may be adapted to connect to this port. The camera ports also may have a dial or wheel that holds multiple lenses of different powers. The male/female attachment port over the camera allows the device to be converted for examination of the skin, eye, ear, nose and throat. The features of such a device allow simultaneous recording or transmission of physiologic information.

It will be appreciated that the system described herein permits doctors and nurses to establish patient protocols and for patient compliance with those protocols to be managed and tracked. The resulting data permits doctors and nurses to track medications with patient outcome to determine the best medications and treatments for various diseases for each patient.

It will also be appreciated that the system described herein may be implemented in software that operates on the web server 20, database 30, and the clients 10 operated by the doctors, nurses, and patients. It will also be appreciated that each such device includes a processor that executed instructions stored in a memory component. The processor may include a standardized processor, a specialized processor, a microprocessor, or the like. The processor may execute instructions including, for example, instructions for enabling the patient's interaction with the system, the doctor or nurse's interaction with the system, and the database's interaction with the system as described herein. On the other hand, the memory component stores the instructions that may be executed by the processor. The memory component may include a tangible computer readable storage medium in the form of volatile and/or nonvolatile memory such as random access memory (RAM), read only memory (ROM, cache, flash memory, a hard disk, or any other suitable storage component. In one embodiment, the memory component may be a separate component in communication with a processor, while in another embodiment, the memory component may be integrated into the processor. Such non-transitory memory components may be used as a computer readable storage device to store the instructions for implementing the methods and software features described herein.

Those skilled in the art also will readily appreciate that many additional modifications are possible in the exemplary embodiment without materially departing from the novel teachings and advantages of the invention. For example, the system described herein may interface with a physician's practice management system to capture patient data. The system may also track whether a patient purchased brand name or generic drugs so that the performance of the generic drug versus the name brand drug may also be tracked for individual patients and aggregates of patients in the database. Accordingly, any such modifications are intended to be included within the scope of this invention as defined by the following exemplary claims.

What is claimed:

1. A method of managing patient care comprising the steps of:
creating, using a processor, a treatment protocol customized for the patient, the patient protocol including one-time events and periodic events relating to patient care and tied to an anchor date;
automatically contacting the patient in a customized manner to notify the patient of one-time and periodic events requiring patient action and accepting indications from the patient of compliance with the required patient action as well as patient symptom data;
storing the customized treatment protocol, patient compliance information and patient symptom data in a database; and
enabling, using said processor, a patient's caregiver to modify the customized patient protocol based on the patient's compliance with any required patient actions and feedback from the patient relating to patient symptoms.

2. A method as in claim 1, wherein the anchor date is a proposed surgery date.

3. A method as in claim 1, wherein automatically contacting the patient in a customized manner includes sending recorded messages to the patient in the patient's caregiver's voice informing the patient of the required patient action according to the patient's customized treatment protocol.

4. A method as in claim 1, further comprising storing the customized treatment protocol, patient compliance information and patient symptom data in the database for many patients and searching the database to find patients with similar treatment conditions for use in predicting which treatment options will work best for the patient and predicting when disease symptoms, drugs side effect and disease itself will occur.

5. A method as in claim 4, further comprising searching the database to find patients with similar treatment conditions by applying weightings to the conditions as specified by the patient's caregiver and identifying the patients with similar treatment conditions using the weighted conditions in a nearest neighbor algorithm.

6. A method as in claim 1, further comprising providing surveys to the patients to elicit the patient symptom data.

7. A method as in claim 6, further comprising enabling the patient's caregiver to dynamically score the respective patient symptoms to vary the weight afforded each patient symptom in evaluation of the patient's condition.

8. A method as in claim 1, further comprising receiving at least one of images and physiologic measurement data from the patient's smart phone indicative of the patient's conditions or symptoms.

9. A system for managing patient care, comprising:
a memory adapted to store computer instructions;
a database; and
a processor adapted to process said computer instructions to implement method for managing patient care comprising the steps of:
creating a treatment protocol customized for the patient, the patient protocol including one-time events and periodic events relating to patient care and tied to an anchor date;
automatically contacting the patient in a customized manner to notify the patient of one-time and periodic events requiring patient action and accepting indications from the patient of compliance with the required patient action as well as patient symptom data;
storing the customized treatment protocol, patient compliance information and patient symptom data in said database; and
enabling a patient's caregiver to modify the customized patient protocol based on the patient's compliance with any required patient actions and feedback from the patient relating to patient symptoms.

10. A system as in claim 9, wherein the anchor date is a proposed surgery date.

11. A system as in claim 9, wherein the processor further executes instructions for automatically contacting the patient in a customized manner by sending recorded messages to the patient in the patient's caregiver's voice informing the patient of the required patient action according to the patient's customized treatment protocol.

12. A system as in claim 9, wherein the processor further executes instructions for storing the customized treatment protocol, patient compliance information and patient symptom data in the database for many patients and searching the database to find patients with similar treatment conditions for use in predicting which treatment options will work best for the patient and predicting when disease symptoms, drugs side effect and disease itself will occur.

13. A system as in claim 12, wherein the processor further executes instructions for searching the database to find patients with similar treatment conditions by applying weightings to the conditions as specified by the patient's caregiver and identifying the patients with similar treatment conditions using the weighted conditions in a nearest neighbor algorithm.

14. A system as in claim 9, wherein the processor further executes instructions for providing surveys to the patients to elicit the patient symptom data.

15. A system as in claim 14, wherein the processor further executes instructions for enabling the patient's caregiver to dynamically score the respective patient symptoms to vary the weight afforded each patient symptom in evaluation of the patient's condition.

16. A system as in claim 9, wherein the processor further executes instructions for receiving at least one of images and physiologic measurement data from the patient's smart phone indicative of the patient's conditions or symptoms.

17. A non-transitory computer readable storage device storing instructions that when executed by a processor cause the processor to implement a method of managing patient care comprising the steps of:
creating a treatment protocol customized for the patient, the patient protocol including one-time events and periodic events relating to patient care and tied to an anchor date;
automatically contacting the patient in a customized manner to notify the patient of one-time and periodic events requiring patient action and accepting indications from the patient of compliance with the required patient action as well as patient symptom data;
storing the customized treatment protocol, patient compliance information and patient symptom data in a database; and
enabling a patient's caregiver to modify the customized patient protocol based on the patient's compliance with any required patient actions and feedback from the patient relating to patient symptoms.

18. A device as in claim 17, further storing instructions that when executed by the processor cause the processor to automatically contact the patient in a customized manner by sending recorded messages to the patient in the patient's caregiver's voice informing the patient of the required patient action according to the patient's customized treatment protocol.

19. A device as in claim 17, further storing instructions that when executed by the processor cause the processor to store the customized treatment protocol, patient compliance information and patient symptom data in the database for many patients and to search the database to find patients with similar treatment conditions for use in predicting which treatment options will work best for the patient and predicting when disease symptoms, drugs side effect and disease itself will occur.

20. A device as in claim 19, further storing instructions that when executed by the processor cause the processor to search the database to find patients with similar treatment conditions by applying weightings to the conditions as specified by the patient's caregiver and identifying the patients with similar treatment conditions using the weighted conditions in a nearest neighbor algorithm.

21. A device as in claim 17, further storing instructions that when executed by the processor cause the processor to enable the patient's caregiver to dynamically score the respective patient symptoms to vary the weight afforded each patient symptom in evaluation of the patient's condition.

22. A device as in claim 17, further storing instructions that when executed by the processor cause the processor to receive at least one of images and physiologic measurement data from the patient's smart phone indicative of the patient's conditions or symptoms.
